(19) United States
(12) Patent Application Publication
(10) Pub. No.: US 2012/0206683 A1
(43) Pub. Date: Aug. 16, 2012

(54) PIXEL ELECTRODE AND ITS ASSOCIATED LCD PANEL

(75) Inventor: Xin Zhang, Shenzhen (CN)

(73) Assignee: Shenzhen China Star Optoelectronics Technology Co. Ltd., Shenzhen, Guangdong (CN)

(21) Appl. No.: 12/999,330

(22) PCT Filed: Nov. 26, 2010
(86) PCT No.: PCT/CN2010/079164

§ 371 Date: Jun. 1, 2011

(30) Foreign Application Priority Data
Nov. 16, 2010 (CN) 201010548736.4

(51) Int. Cl. G02F 1/1343

(52) U.S. Cl. 349/139

(57) ABSTRACT

The present invention discloses a pixel electrode of a liquid crystal display (LCD) panel. The pixel electrode has a specific layout. The pixel electrode contains a peripheral portion, slits, and a central part which reserves an opening. When a voltage is applied to the pixel electrode, LC molecules are slanted starting inward moving outward, preventing the central domain of the pixel electrode from being squeezed. Accordingly, the central domain without the pixel electrode can be designed to be smaller, bringing about a decrease in the non-opening domain of the LCD panel and further, a larger aperture rate of the LCD panel.

### BACKGROUND OF THE INVENTION

1. Field of the Invention

The present invention relates to a pixel electrode and its associated liquid crystal display (LCD) panel, and more particularly to a pixel electrode having a peripheral portion and slits capable of improving an aperture rate of an LCD panel and its associated LCD panel.

2. Description of Prior Art

A monitor with multiple functions is a key element for use in current consumer electronic products. The demand for the novelty and colorful monitors with high resolution, e.g., liquid crystal displays (LCDs), are indispensable components used in various electronic products such as monitors for notebook computers, personal digital assistants (PDAs), digital cameras, and projectors.

An LCD panel comprises a backlight module and an LCD panel. A traditional LCD panel comprises two substrates and a liquid crystal (LC) layer sandwiched by the two substrates. In general, an alignment film is formed on both of the substrates during the LCD panel manufacturing process, so that liquid crystal (LC) molecules can be arranged in a specific direction. In a traditional method of forming alignment films, an alignment material is coated and then the alignment material undergoes an alignment process.

Currently, a technology called polymer stabilized vertical alignment (PSVA) has been developed by the industry. The PSVA technology is that LC material is mixed with monomers having an appropriate concentration, and then the mixed LC material is shaken evenly. Next, the mixed LC material is placed on a heater and heated until it achieves isotropy. When the mixed LC material reaches room temperature, it tends to go back to a nematic state. Subsequently, the mixed LC material is injected into an LC cell, and a voltage is applied to the LC cell. The voltage makes the LC molecules be arranged stably in the cell. Then, the mixed LC material is polymerized by exposing under ultraviolet (UV) light or by heating in order to form a polymer layer. In this way, alignment stability can be achieved.

In general, for a pixel structure for use in a PSVA LCD panel, there are alignment slits formed on a pixel electrode to make the LC molecules be aligned in a specific direction. Refer to FIG. 1, which is an enlarged diagram of a pixel in a conventional PSVA LCD panel. The PSVA LCD comprises a data line DL, a scan line SL, a thin-film transistor (TFT) 114, and a pixel electrode 110 as FIG. 1 shows. The pixel electrode 110, disposed within the pixel domain, is a snowflake-like pattern. The pixel electrode 110 comprises a vertical main trunk 111 positioned at the center, a horizontal main trunk 112 positioned at the center, and slits 113 slanted away from the X axis by ±45 degrees and ±135 degrees. The vertical main trunk 111 and the horizontal main trunk 112 divide a pixel into four equal domains. The slits 113 slanted at a 45-degree angle are paved inside the four domains.

Therefore, an electrode pattern which illustrates upper-lower and left-right mirror-image symmetry like a snowflake is completed.

In this electrode pattern, part of the slits 113 is electrically connected to the TFT 114 for transmitting the voltage from the scan line SL to the pixel electrode 110.

Refer to FIG. 2, which illustrates an alignment of the LC molecules when a constant voltage (e.g., 4 volts) is applied to the pixel electrode 110 in FIG. 1. As FIG. 2 shows, when the voltage is applied to the snowflake-like pixel electrode 110, the LC molecules become slanted gradually toward the inside of the pixel electrode 110 from the outside of the pixel electrode 110. The slanted angle of the LC molecules in each domain extends in a direction in which the slits 113 of the same domain extend. The slanted angle of LC molecules in each of the four domains is ±45 and ±135 degrees, respectively. All of the slanted LC molecules in the four domains are directed toward the center of the pixel domain. For a detailed explanation, as FIG. 2 shows, the included angle between the direction of the inverted LC molecules in each domain and the X axis (the scan line) is: −135 degrees in the first quadrant, −45 degrees in the second quadrant, 45 degrees in the third quadrant, and 135 degrees in the forth quadrant.

Refer to FIG. 3, which illustrates an alignment of the LC molecules corresponding to a cross section view along a dotted line from point A to point B to point C in FIG. 1. As FIG. 3 shows the cross section view along the dotted line (perpendicular to the cross section of the sheet surface) in FIG. 1, the LC molecules are slanted toward the inside of the pixel electrode 110 from the outside of the pixel electrode 110. The slanted LC molecules are directed toward the inside of the pixel.

It is notified that, the pixel electrode 110 highly relies on the vertical main trunk 111 and the horizontal main trunk 112 at the center according to the prior art. Basically, the vertical main trunk 111 and the horizontal main trunk 112 are opaque domains. It is because the inverted LC molecules inside the vertical main trunk 111 and the horizontal main trunk 112 are directed toward the main trunks. The included angle between the inverted LC molecules of the vertical main trunk 111 and the X axis is zero degree; the included angle between the inverted LC molecules of the horizontal main trunk 112 and the X axis is 90 degrees. The included angle between a upper polarizer film and the X axis is fixed as zero degree; the included angle between a lower polarizer film and the X axis is fixed as 90 degrees. Therefore, a transmissive rate of the vertical main trunk 111 and of the horizontal main trunk 112 is zero based on a formula for transmissive rate. On the other hand, both of the vertical main trunk 111 and the horizontal main trunk 112 have a very large area, resulting in a decrease in an aperture rate of the LCD panel.

As a result, the industry needs to develop a pixel electrode pattern having a larger aperture rate.

### SUMMARY OF THE INVENTION

An object of the present invention is to provide a pixel electrode pattern with its associated LCD panel. The pixel electrode pattern can increase an aperture rate of the LCD panel, and further, the pixel electrode pattern can solve problems occurring in the prior art.

According to the present invention, a pixel electrode of a liquid crystal display (LCD) panel is provided. The LCD panel comprises a scan line, a switch unit, and a pixel domain. One terminal of the switch unit is electrically connected to the scan line. The pixel electrode is disposed in the pixel domain. The pixel electrode comprises a peripheral portion and a plurality of slits. The peripheral portion is electrically connected to another terminal of the switch unit. The plurality of slits are surrounded by the peripheral portion and connected to the peripheral portion. An opening is located in a center of the plurality of slits, and divides the plurality of slits into at least two domains.

According to the present invention, a liquid crystal display (LCD) panel comprises a scan line, a switch unit, a pixel electrode, and a pixel domain. One terminal of the switch unit is electrically connected to the scan line. The pixel electrode is disposed in the pixel domain. The pixel electrode comprises a peripheral portion and a plurality of slits. The peripheral portion is electrically connected to another terminal of the switch unit. The plurality of slits are surrounded by the peripheral portion and connected to the peripheral portion. An opening is located in a center of the plurality of slits, and divides the plurality of slits into at least two domains.

In contrast to the prior art, the pixel electrode and its associated LCD panel of the present invention comprises a peripheral portion and slits. The present invention reduces the domain of the central main trunk of the prior art, so an opaque domain is reduced greatly. As a result, an aperture rate of the LCD panel is successfully improved.

These and other features, aspects and advantages of the present disclosure will become understood with reference to the following description, appended claims and accompanying figures.

### BRIEF DESCRIPTION OF THE DRAWINGS

FIG. 1 is an enlarged diagram of a pixel in a conventional PSVA LCD panel.

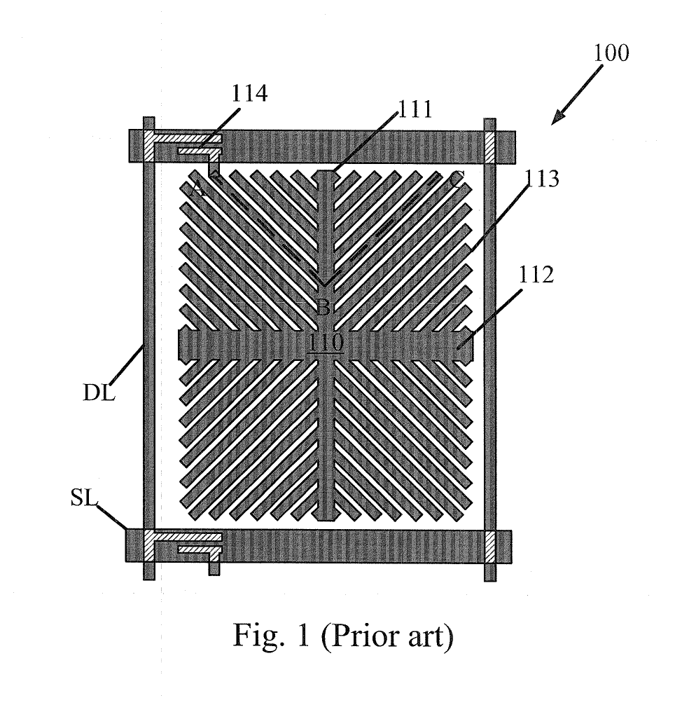

FIG. 2 illustrates an alignment of the LC molecules when a constant voltage is applied to the pixel electrode in FIG. 1.

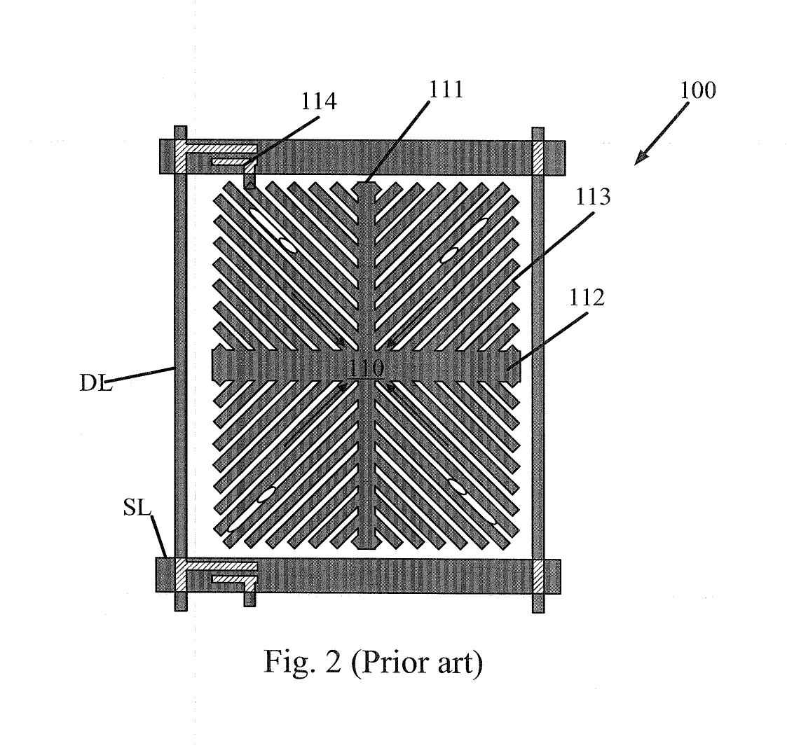

FIG. 3 illustrates an alignment of the LC molecules corresponding to a cross section view along a dotted line from point A to point B to point C in FIG. 1.

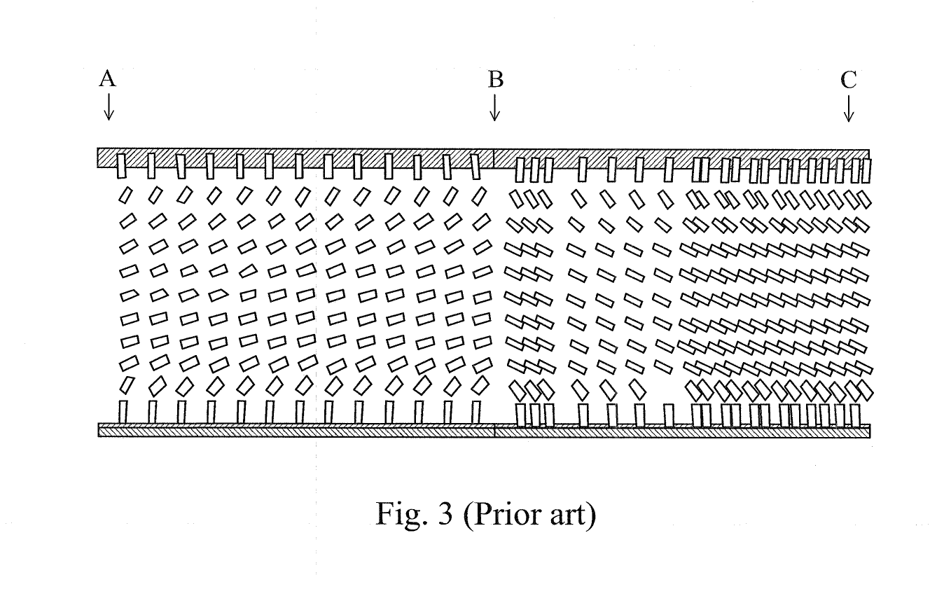

FIG. 4 is an enlarged diagram of a pixel in an LCD panel according to a preferred embodiment of the present invention.

FIG. 5 illustrates an alignment of the LC molecules when a voltage is applied to the pixel electrode in FIG. 4.

FIG. 6 illustrates an alignment of the LC molecules corresponding to a cross section view along a dotted line from point A to point B to point C in FIG. 4.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

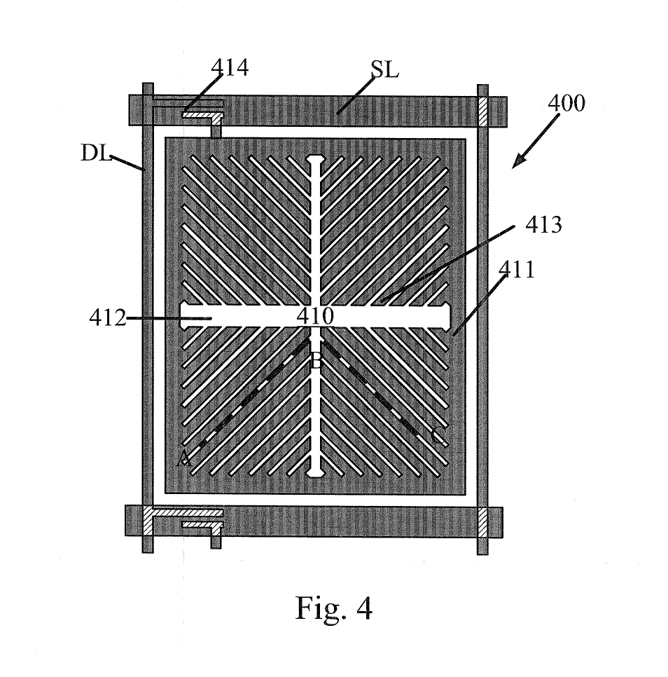

Refer to FIG. 4, which is an enlarged diagram of a pixel in an LCD panel according to a preferred embodiment of the present invention. According to the present embodiment, the LCD panel 400 uses a PSVA LCD pane. The LCD panel 400 comprises a data line DL, a scan line SL, a switch unit 414, and a pixel electrode 410. Preferably, the switch unit 414 is a TFT or any other switch unit having a similar switch function. As FIG. 4 shows, the pixel electrode 410 is disposed within the pixel domain. The pattern of the pixel electrode 410 is different from that of the aforementioned pixel electrode 110. The pixel electrode 410 comprises a square-shaped peripheral portion 411 and slits 413 surrounded by the peripheral portion 411. An opening 412 is located in a center of the slits 413. The opening 412 divides the pixel electrode into four roughly equal domains. The slits 413 slanted at a 45-degree angle are paved within the four domains.

The peripheral portion 411 is electrically connected to one terminal of the switch unit 414. The other terminal of the switch unit 414 is electrically connected to the scan line SL. So the voltage applied to the scan line SL can be transmitted to the pixel electrode 410 by means of the conduction of the switch unit 414 and the peripheral portion.

The slits 413 of each of the four domains have their individual direction. The included angle between each of the slits 413 in the four domains and the X axis (the scan line SL) is ±45 degrees and ±135 degrees, respectively. According to a preferred embodiment of the present invention, all of the slits 413 of the domains are directed toward the center of the pixel domain. That is, as FIG. 4 shows, the included angle between the slits 413 in the first quadrant and the scan line SL is −135 degrees; the included angle between the slits 413 in the second quadrant and the scan line SL is −45 degrees; the included angle between the slits 413 in the third quadrant and the scan line SL is 45 degrees; the included angle between the slits 413 in the fourth quadrant and the scan line SL is 135 degrees. It should be notified that, however, the included angle between each of the slits 413 of the four domains and the scan line SL only applies to the embodiment of the present invention. These included angles are not intended to limit the present invention. Designers can design other included angles depending on their demands. Such corresponding changes also belong to the scope of the present invention.

Moreover, it is notified that, although the peripheral portion 411 is shaped as a square according to the present embodiment, it can be shaped as a circle, a regular hexagon, a regular octagon, or any other shapes in practical applications. In other words, the peripheral portion 411 is not restricted to being a square. It is also notified that, although the opening 412 is cruciform according to the present embodiment, it not restricted to a cruciform pattern; instead, the opening 412 can show a straight-line-shaped pattern or a snowflake-like pattern. As long as an opening can divide the slits 413 into upper and lower parts or left and right parts displaying upper-lower or left-right minor-image symmetry, it is within the scope of the present invention.

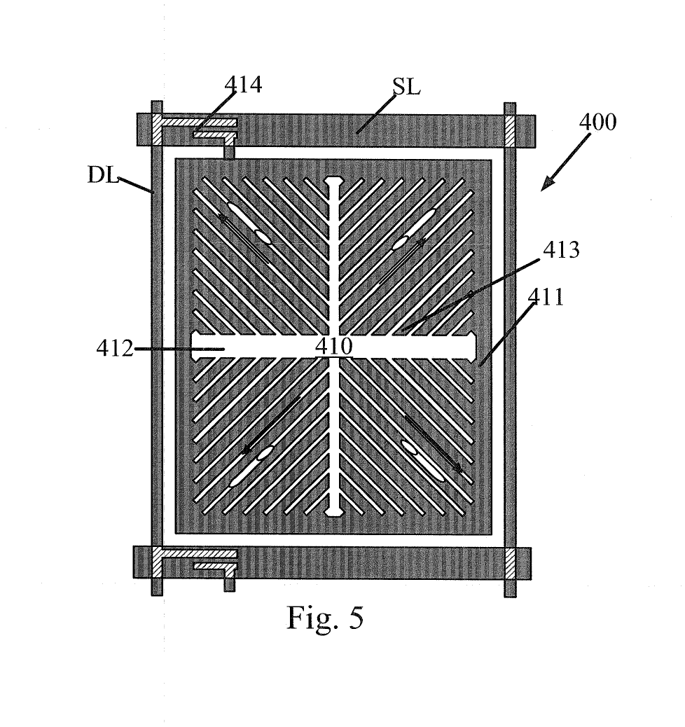

Refer to FIG. 5, which illustrates an alignment of the LC molecules when a voltage is applied to the pixel electrode 410 in FIG. 4. As FIG. 5 shows, when the voltage is applied to the pixel electrode 410, the LC molecules become slanted gradually toward the outside of the pixel electrode 410 from the inside of the pixel electrode 410. The slanted angle of the LC molecules in each domain extends in the direction of the slits 413 of the same domain. The slanted LC molecules in the four domains have a direction of ±45 and ±135 degrees, respectively. The directions of the slanted LC molecules indicate four corners of the pixel domain from the center of the pixel domain.

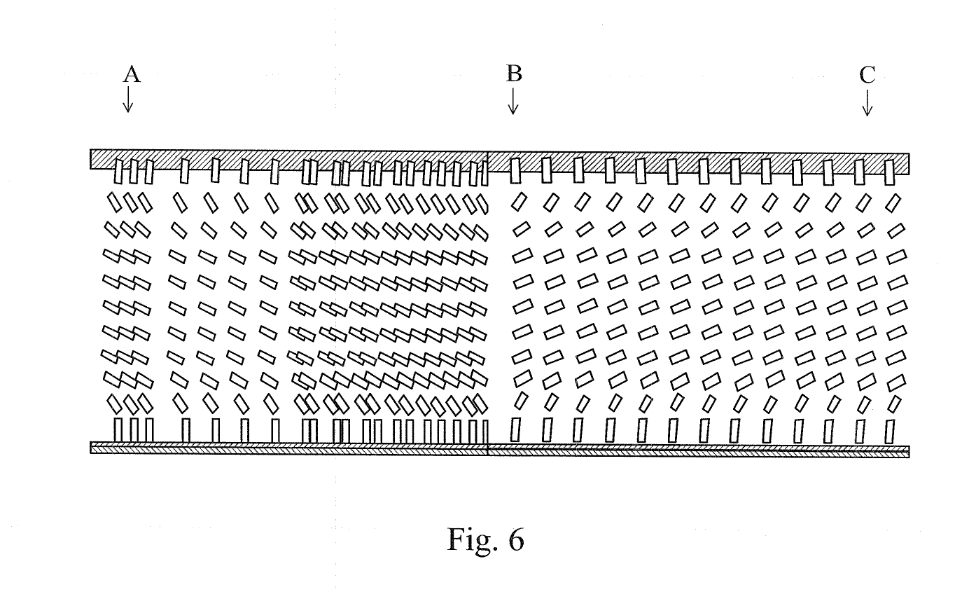

Refer to FIG. 6, which illustrates an alignment of the LC molecules corresponding to a cross section view along a dotted line from point A to point B to point C in FIG. 4. As FIG. 6 shows the cross section along the dotted line (perpendicular to the cross section of the sheet surface) in FIG. 4, the LC molecules are slanted toward the outside of the pixel electrode 410 from the inside of the pixel electrode 410. The slanted LC molecules indicate four corners of the pixel. In other words, the LC molecules are slanted inward to outward when the voltage is applied to the pixel electrode 410. So the central domain of the pixel electrode 410 can be prevented from being squeezed. Thus, in a preferred embodiment of the present invention, designers can reduce the domain of the central opening 412 (the domain without ITO) as much as possible. In this way, the non-opening domain is greatly reduced and the aperture rate becomes relatively larger.

It is notified that, the pattern of the pixel electrode 410 is not difficult for the one skilled in this art; that is, no specific process is required to form the pattern of the pixel electrode 410. The pattern of the pixel electrode 410 of the present invention can directly substitute for the pixel electrode 110 of the prior art. The one skilled in this art should fully understand the descriptions, so no details for the process are provided.

In contrast to the prior art, the LCD panel of the present invention comprises a pixel electrode having a specific pattern. The pixel electrode comprises a peripheral portion and slits, removing an opaque main trunk of the pixel electrode in the prior art. Thus, the pixel electrode of the present invention has a larger transmittable domain, providing the LCD panel of the present invention with a larger aperture rate.

The pixel electrode of the present invention is qualified to be applied to a PSVA LCD panel, a twisted nematic (TN) LCD panel, a pattern vertical alignment (PVA) LCD panel, and so on.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A pixel electrode of a liquid crystal display (LCD) panel, the LCD panel comprising a scan line, a switch unit, and a pixel domain, the pixel electrode being disposed in the pixel domain, characterized in that:
a peripheral portion electrically connected to another terminal of the switch unit; and
a plurality of slits surrounded by the peripheral portion and connected to the peripheral portion,
wherein an opening located in a center of the plurality of slits, and divides the plurality of slits into four domains, so that the four domains are minor-image symmetry.

2. The pixel electrode of claim 1 characterized in that, the peripheral portion is shaped as a square.

3. The pixel electrode of claim 1 characterized in that a direction of the slits of one of the four domains differs from that of the slits of one another domain.

4. The pixel electrode of claim 3 characterized in that an included angle between a direction of the plurality of slits and the scan line corresponds to ±45 degrees or ±135 degrees, respectively.

5. The pixel electrode of claim 3 characterized in that the opening is profiled as a cross.

6. A pixel electrode of a liquid crystal display (LCD) panel, the LCD panel comprising a scan line, a switch unit, and a pixel domain, the pixel electrode being disposed in the pixel domain, characterized in that the pixel electrode comprises:
a peripheral portion electrically connected to another terminal of the switch unit; and
a plurality of slits surrounded by the peripheral portion and connected to the peripheral portion,
wherein an opening is located in a center of the plurality of slits, and divides the plurality of slits into at least two domains.

7. The pixel electrode of claim 6 characterized in that the peripheral portion is shaped as a square.

8. The pixel electrode of claim 6 characterized in that the opening is profiled as a cross, and the opening divides the plurality of slits into four domains.

9. The pixel electrode of claim 8 characterized in that a direction of the slits of one of the four domains differs from that of the slits of one another domain.

10. The pixel electrode of claim 9 characterized in that an included angle between a direction of the plurality of slits and the scan line corresponds to ±45 degrees or ±135 degrees, respectively.

11. The pixel electrode of claim 6 characterized in that the opening is profiled as a straight line.

12. The pixel electrode of claim 6 characterized in that the opening is profiled as a snowflake.

13. The pixel electrode of claim 6 characterized in that every neighboring two of the plurality of slits have an equal gap.

14. A liquid crystal display (LCD) panel, the LCD panel comprising a scan line, a switch unit, a pixel electrode, and a pixel domain, one terminal of the switch unit being electrically connected to the scan line, the pixel electrode being disposed in the pixel domain, characterized in that the pixel electrode comprises:
a peripheral portion electrically connected to another terminal of the switch unit; and
a plurality of slits surrounded by the peripheral portion and connected to the peripheral portion,
wherein an opening located in a center of the plurality of slits, and divides the plurality of slits into at least two domains.

15. The LCD panel of claim 14 characterized in that the opening is profiled as a cross, and the opening divides the plurality of slits into four domains.

16. The LCD panel of claim 15 characterized in that a direction of the slits of one of the four domains differs from that of the slits of one another domain.

17. The LCD panel of claim 14 characterized in that every neighboring two of the plurality of slits have an equal gap.

18. The LCD panel of claim 14 characterized in that the opening is profiled as a straight line.

19. The LCD panel of claim 14 characterized in that the opening is profiled as a snowflake.

20. The LCD panel of claim 14 characterized in that the switch unit is a thin-film transistor.
